(19) United States
(12) Patent Application Publication
(10) Pub. No.: US 2013/0106231 A1
(43) Pub. Date: May 2, 2013

(54) CONDUCTOR WELD-END LENGTH CONTROL FORMING

(71) Applicants: Brad Chamberlin, Pendleton, IN (US); Colin Hamer, Noblesville, IN (US)

(72) Inventors: Brad Chamberlin, Pendleton, IN (US); Colin Hamer, Noblesville, IN (US)

(73) Assignee: REMY TECHNOLOGIES, L.L.C., Pendleton, IN (US)

(21) Appl. No.: 13/282,954

(22) Filed: Oct. 27, 2011

(51) Int. Cl. H02K 3/28; H02K 15/00

(52) U.S. Cl. 310/201; 29/596

(57) ABSTRACT

A method of joining a plurality of electrical conductors in an electric machine. The method comprises the steps of providing a core and positioning the plurality of conductors within the core in concentric rings. The conductors include ends extending from the core. The method further comprises the steps of holding together at least two adjacent ends of the conductors, joining the adjacent ends to form a joint, and forming the joint to include at least a substantially planar portion. The method further comprises the step of releasing the adjacent ends of the conductors.

### BACKGROUND AND SUMMARY OF THE DISCLOSURE

The present invention relates generally to electric machines and, more particularly, to a method of joining the conductors of a stator assembly within electric machines.

Electric machines may be used for a variety of applications, including in connection with automobile power trains. For example, a conventional automobile may use an electric machine as a starting motor for an internal combustion engine, or as an alternator to generate electricity and deliver power to vehicle accessories and/or charge a vehicle's battery.

An illustrative electric machine includes a rotor and a stator. The stator is comprised of a stator stack and a plurality of conductors, or windings, that are inserted into the stator stack. The windings are interconnected (e.g., welded together) at weld-end turns or joints in order to form a circuit that is necessary for operation of the electric machine. In particular, the electric machine operates when the stator interacts with the rotor through magnetic fields to convert electric energy to mechanical energy, or to convert mechanical energy to electric energy.

Some stators are positioned in small or confined spaces and it may be desirable to reduce the overall package size or height of the stator. For example, the length of the weld-end turns extending from the stator may be reduced to decrease the package size of the stator. However, conventional size-reduction processes that are performed after the ends of the windings have been welded together and the weld-end turns have cooled, may cause debris that could contaminate the stator (e.g., metallic shavings from a machining process).

The present disclosure relates to an illustrative method of joining a plurality of electrical conductors in an electric machine. The method comprises the steps of providing a core and positioning the plurality of conductors within the core in concentric rings. The conductors include ends extending from the core. The method further comprises the steps of holding together at least two adjacent ends of the conductors, joining the adjacent ends to form a joint, and forming the joint to include at least a substantially planar portion. The method further comprises the step of releasing the adjacent ends of the conductors.

According to another illustrative method of the present disclosure, a plurality of electrical conductors in an electric machine are joined. The method comprises the steps of providing a core and positioning the plurality of conductors within the core. Each conductor includes an end extending from the core. The method further comprises the step of joining a pair of adjacent ends of the conductors with heat to form a joint. The joint includes a raised arcuate surface. The method further comprises the step of engaging the joint with a forming device at a predetermined level below the raised arcuate surface of the joint.

According to a further illustrative embodiment of the present disclosure, an electric machine assembly comprises a core and a plurality of electrical conductors supported by the core in an axial direction. The plurality of electrical conductors forms concentric rings and each conductor includes an end extending from the core. Each end of the conductors is coupled to an adjacent end of the conductors to form a joint. The joint has at least a substantially planar portion perpendicular to the axial direction.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The foregoing aspects and many of the intended advantages of this invention will become more readily appreciated as the same becomes better understood by reference to the following detailed description when taken in conjunction with the accompanying drawings.

FIG. 1 is a front perspective view of an illustrative stator assembly;

FIG. 2 is a detailed front perspective view of a plurality of electrical conductors of the illustrative stator assembly of FIG. 1, prior to being coupled at weld-end turns or joints with the illustrative method of the present disclosure;

FIG. 3 shows illustrative holding and joining steps for coupling adjacent ends of the electrical conductors according to an illustrative method of the present disclosure;

FIGS. 4A-4B show an illustrative forming step applied to a weld-end joint of adjacent ends of the electrical conductors according to the illustrative method;

FIG. 4C is a cross-sectional view of a representative weld-end joint as formed through the illustrative method shown in FIGS. 4A-4B;

FIGS. 5A-5B show an alternative forming step of the illustrative method;

FIGS. 6A-6B show another alternative forming step of the illustrative method;

FIG. 6C is a cross-sectional view of a representative weld-end joint as formed through the illustrative method shown in FIGS. 6A-6B;

FIG. 7 is a detailed front perspective view of a pair of weld-end joints of the electrical conductors of the type shown in FIG. 4C; and

FIG. 8 is a detailed front perspective view of a pair of alternative weld-end joints of the electrical conductors of the type shown in FIG. 6C.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplifications set out herein illustrate embodiments of the invention, and such exemplifications are not to be construed as limiting the scope of the invention in any manner.

### DETAILED DESCRIPTION OF THE DRAWINGS

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrated devices and described methods and further applications of the principles of the invention which would normally occur to one skilled in the art to which the invention relates.

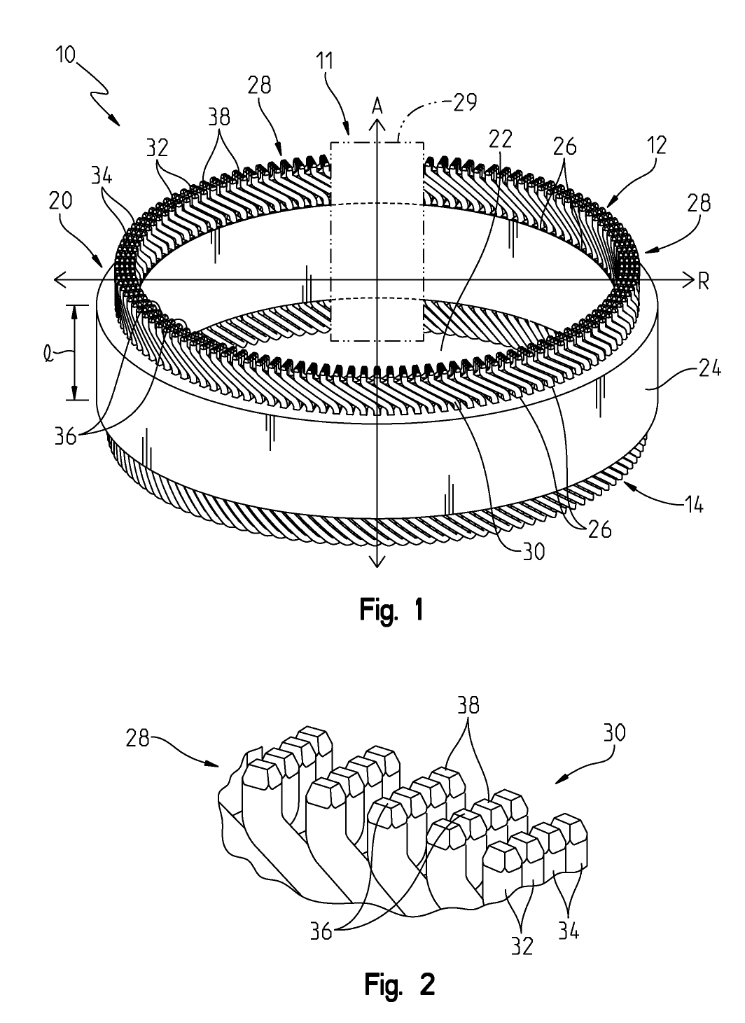

Referring initially to FIG. 1, an illustrative stator assembly 10 of an electric machine 11 is shown. The stator assembly 10 includes an insertion end 14 and a connection end 12. The electric machine 11 when used as a motor (such as a starting motor or traction motor) includes the stator assembly 10 operably coupled to a rotor (not shown) through magnetic fields in order to convert electric energy to mechanical energy. In a similar manner, the electric machine 11 may also be used as an alternator or generator to generate electricity by converting mechanical energy to electric energy through magnetic fields and delivering power, for example, to vehicle accessories and/or to charge a vehicle's battery.

The stator assembly 10 is illustratively comprised of a core support or stator stack 20, and a plurality of electrical conductors, or windings 30. The stator stack 20 includes a cylindrical wall 24 and an open center portion 22. An axial direction A extends through the open center portion 22 of the stator stack 20 and a radial direction R is perpendicular to the axial direction A. The cylindrical wall 24 may include one or more lamination stacks or layers (not shown). The cylindrical wall 24 may be comprised of silicon steel, which reduces hysteresis and eddy current losses during operation of the electric machine 11. Alternatively, the cylindrical wall 24 may be comprised of a solid powered metal body. Furthermore, the stator stack 20 may include a metal (e.g., steel) frame (not shown).

The cylindrical wall 24 of the stator stack 20 illustratively includes a plurality of circumferentially-spaced, axially-extending slots 26 through which the conductors 30 are received. The slots 26 may include an insulating material (e.g., varnish, foam, gel, spray) (not shown) to fill voids or spaces between the conductors 30 and the cylindrical wall 24 of the stator stack 20, along with voids between conductors 30. The slots 26 extend along the length l of the cylindrical wall 24 of the stator stack 20. The slots 26 each illustratively support at least a portion of conductors 30.

The stator assembly 10 illustratively includes a commons region 28 and a specials region 29, which are comprised of the conductors 30. The specials region 29 determines the type and configuration of the stator assembly 10. As is known in the art, the specials region 29 may include, for example, neutral conductors, phase conductors, cross-over conductors, and leads for coupling with external electrical components (not shown).

The conductors 30 within the commons region 28 are positioned within slots 26 of the stator stack 20. The conductors 30 may have different maximum voltage capacities (e.g., approximately 120 volts (V)), depending on the function of the stator assembly 10.

Referring to FIG. 2, the illustrative conductors 30 have a rectangular cross-section, although other cross-sectional shapes (e.g., circular) may be substituted therefore. The efficiency of the electric machine 11 may be improved by increasing the slot-fill-ratio (SFR) of the machine 11. The SFR is a comparison of the aggregate cross-sectional area of the conductors 30 in one of the slots 26 and the cross-sectional area of the slot 26 itself. If the electric machine 11 has a high SFR, the cross-sectional area of the conductors 30 reduces the phase resistance and the resistance of the conductors 30 for a given size of the slots 26. Conductors 30 illustratively have a rectangular cross-section, rather than a circular cross-section, in order to contribute to a higher SFR for the machine 11. Therefore, the efficiency of the machine 11 may be improved.

Illustratively in FIGS. 1 and 2, the commons region 28 of the stator assembly 10 includes pairs of inner conductors 32 adjacent the open center portion 22 of the stator stack 20 and pairs of outer conductors 34 spaced radially outward from the inner conductors 32. The representative pairs of inner and outer conductors 32, 34 form radially-spaced concentric rows or rings of conductors 30. A typical stator assembly 10 may include different numbers of conductors 30 (e.g., 120 conductors 30, or 240 conductors 30), depending on the desired power, magnetic, and other operational requirements of the stator assembly 10.

The inner conductors 32 have ends 36 illustratively extending from the connection end 12 of the stator assembly 10 (FIG. 1). Likewise, the outer conductors 34 have ends 38 extending from the connection end 12. The ends 36, 38 of the respective inner and outer conductors 32, 34 illustratively extend approximately 34 millimeters from the top of the cylindrical wall 24 of the stator stack 20. Each conductor wire 30 may be bent or shaped into a more compact configuration during assembly of the stator assembly 10. The conductors 30 may be shaped according to the teachings of U.S. Pat. No. 6,894,417 to Cai et al., which issued on May 17, 2005, and is assigned to Remy Inc. of Anderson, Ind., the disclosure of which is expressly incorporated by reference herein. More particularly, the conductors 30 are bent to form a hairpin-shape, or U-shape, however, the conductors 30 may be bent into other shapes.

Referring again to FIG. 1, the ends 36, 38 of the conductors 30 extend from the slots 26 of the stator stack 20 and are staggered, or “interleaved” (i.e., positioned through a different slot 26 with respect to adjacent conductors 30). The ends 36, 38 of the conductors 30 extending from the slots 26 are interconnected to form at least one circuit. For example, the conductors 30 may interconnect to form a single-phase circuit, a two-phase circuit, or a three-phase circuit.

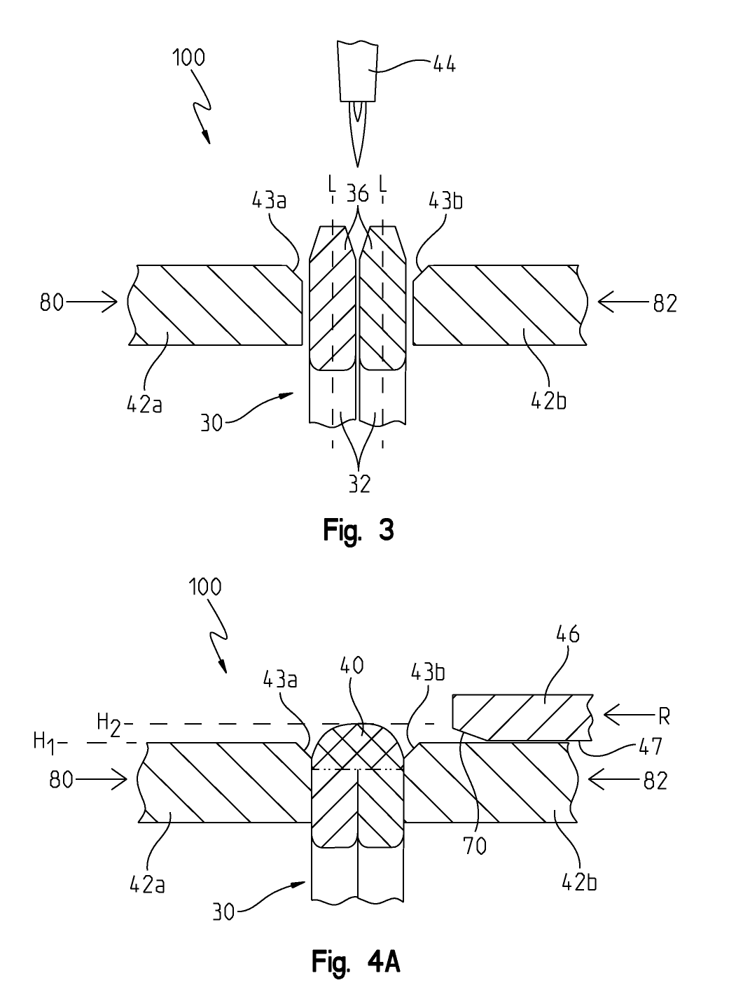

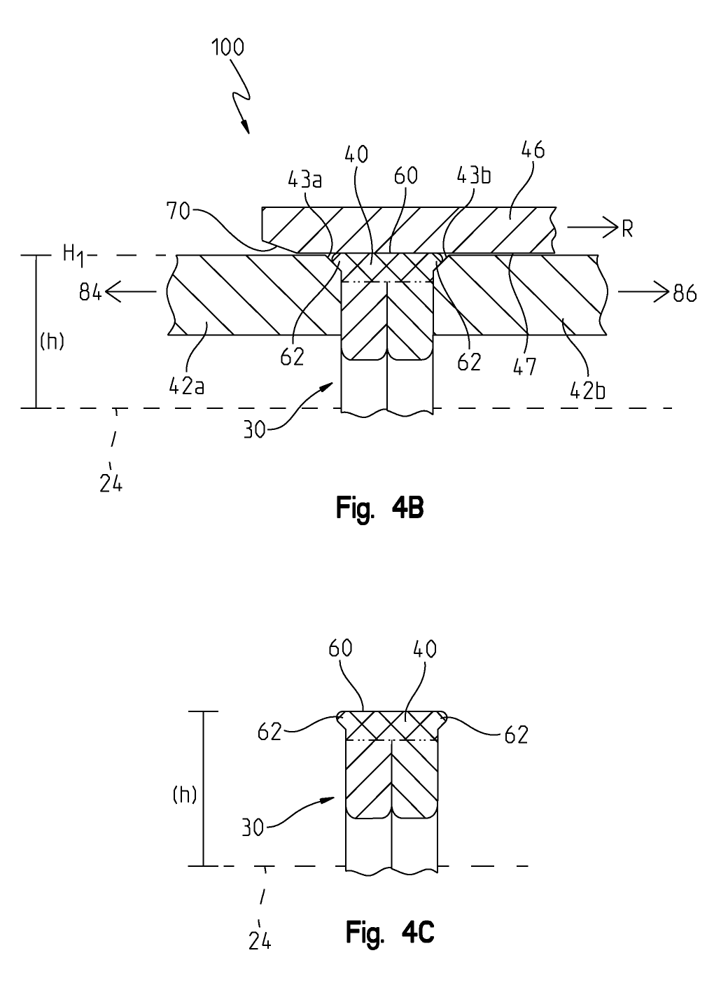

Referring to FIGS. 3-6, a coupling machine 100 may be used to join radially adjacent ends 36, 38 of respective conductors 32, 34 to form a weld-end turn or joint 40. The coupling machine 100 also reduces the height (h) of the joint 40 extending outwardly from the stator stack 20 in order to decrease the package size of the stator assembly 10 for easier positioning in small spaces. Illustratively, for example in FIG. 4C, the height (h) of the joint 40 extends from the top of the cylindrical wall 24 of the stator stack 20 to the top of the joint 40. The illustrative coupling machine 100 may include a holding device, illustratively a clamping device, a joining device, illustratively a welding device, and a forming device, illustratively a pressing device or die. The holding, joining, and forming devices may be operably coupled together or may be individual devices separable from the coupling machine 100.

With reference to FIG. 3, the holding device of the coupling machine 100 includes supports or clamps 42 that hold the ends 36, 38 of the conductors 30 together. Illustratively, a first clamp 42a and a second clamp 42b may be configured to move toward the conductors 30 in opposing directions 80, 82 along the radial direction R of the stator stack 20, which is transverse to a longitudinal axis L of the conductors 30. The illustrative embodiment of first and second clamps 42a, 42b are approximately four millimeters in height. The first and second clamps 42a, 42b may include a respective ramp 43a, 43b, which will be described in further detail hereinafter.

The joining device of the coupling machine 100 is an illustrative welding torch 44 (FIG. 3). The torch 44 may be a plasma torch or any other conventional heating device for melting and welding metals. The illustrative torch 44 may be positioned above the conductors 30 and parallel to the longitudinal axis L of the conductors 30 and the axial direction A. Alternatively, the torch 44 may be positioned along a side of the conductors 30. The torch 44 welds together the ends 36, 38 of the conductors 30 in order to form the joint 40.

Illustratively, as shown in FIGS. 4A and 4B, the forming device of the coupling machine 100 may be a radial forming die 46 with an engagement surface 47. The radial forming die 46 is configured to move in the radial direction R and perpendicular to the longitudinal axis L of the conductors 30 to apply a radial force to the joint 40. The engagement surface 47 includes a leading edge 70 to guide the radial forming die 46 as it moves across the joint 40. The leading edge 70 is angled relative to the engagement surface 47, the joint 40, and the upper surface of the clamps 42. The engagement surface 47 contacts the joint 40 at a predetermined height as the radial forming die 46 moves in the radial direction R. The illustrative engagement surface 47 of the radial forming die 46 is substantially planar.

Alternatively, the engagement surface 47 of the radial forming die 46 may be configured to roll or pivot as the radial forming die 46 moves in the radial direction R across the top surface of the joint 40. As such, the rolling motion of the alternative embodiment radial forming die 46 applies both a radial and axial load to the joint 40. The engagement surface 47 of the radial forming die 46 may have an arcuate, illustratively cylindrical, shape to facilitate the rolling motion across the joint 40. Additionally, the engagement surface 47 may include an identifying mark or indicia with a controlled form (e.g., a logo, a trademark, a numeral, an alphabetic letter) that can be transferred to the joint 40 during the rolling motion.

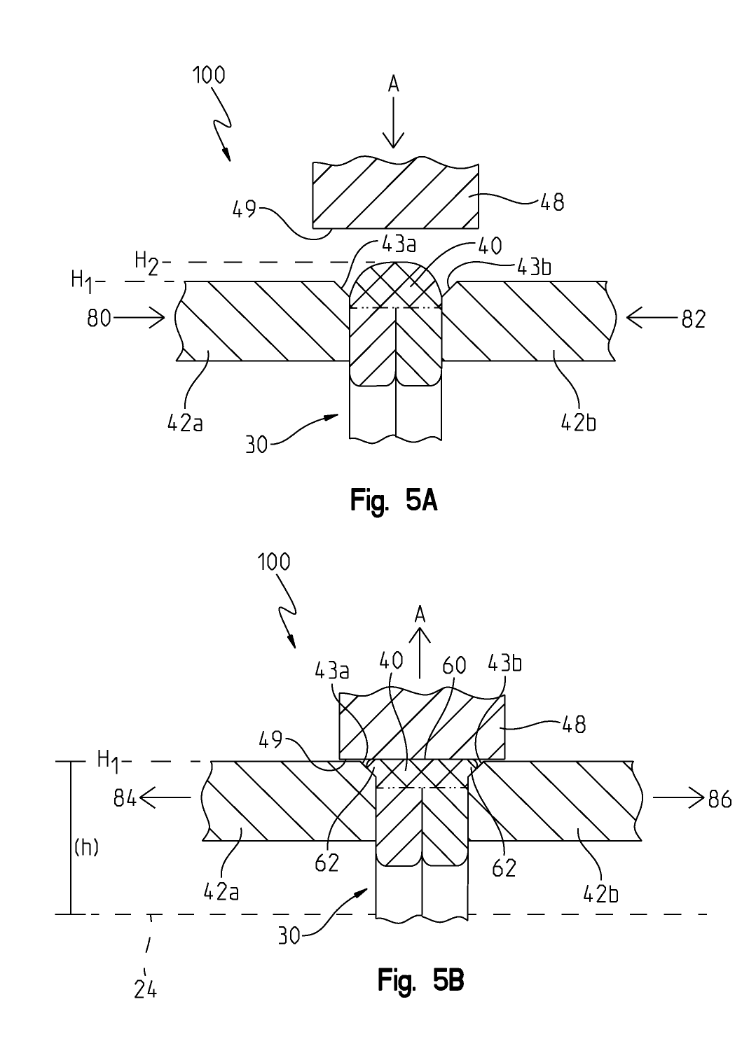

Alternatively, another embodiment of the forming device of the coupling machine 100 may include an axial forming die 48, as illustrated in FIGS. 5A and 5B. The axial forming die 48 has an engagement surface 49 and is configured to move in the axial direction A to apply an axial load to the joint 40. In other words, the axial forming die 48 moves parallel to the longitudinal axis L of the conductors 30 and perpendicular to the radial direction R. The axial forming die 48 is configured to move downwardly to a predetermined height with respect to the joint 40. Similar to the radial forming die 46 (FIGS. 4A and 4B), the illustrative engagement surface 49 of the axial forming die 48 is substantially planar, however, the engagement surface 49 also may include an identifying mark or indicia with a controlled form (e.g., a logo, a trademark, a numeral, an alphabetic letter) (not shown) that can be transferred to the joint 40.

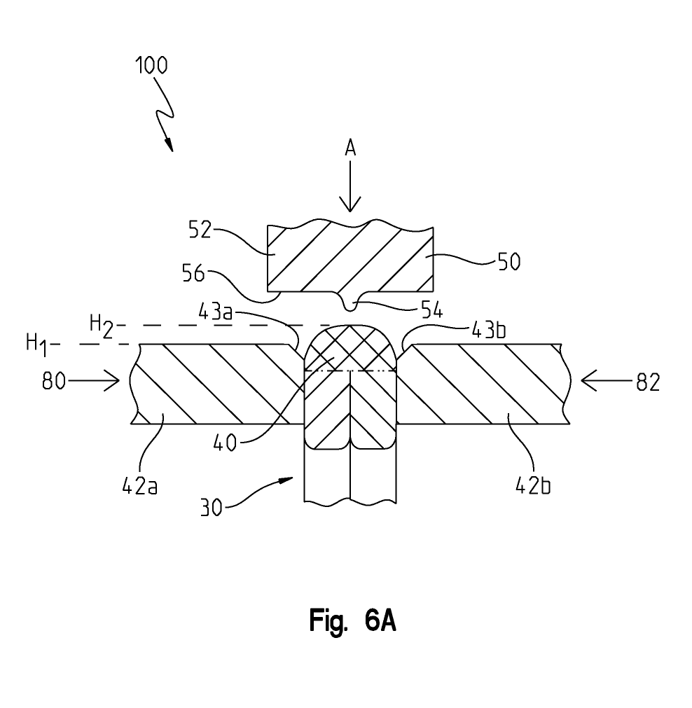

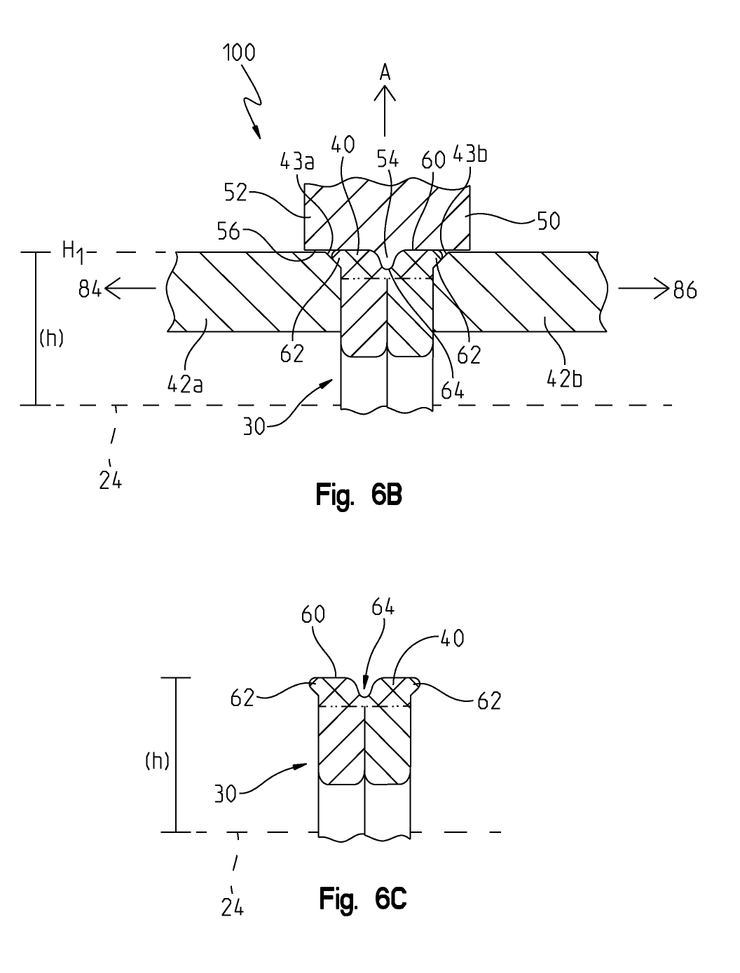

Referring to FIGS. 6A and 6B, another alternative embodiment of the forming device of the coupling machine 100 may include a profile forming die 50. The illustrative profile forming die 50 includes a body 52, a projection 54, and an engagement surface 56. The profile forming die 50 may be configured to move in the axial direction A to a predetermined height. The illustrative engagement surface 56 of the profile forming die 50 has a substantially planar portion surrounding the projection 54, however, the engagement surface 56 may also include an identifying mark (not shown) that may be transferred to the joint 40.

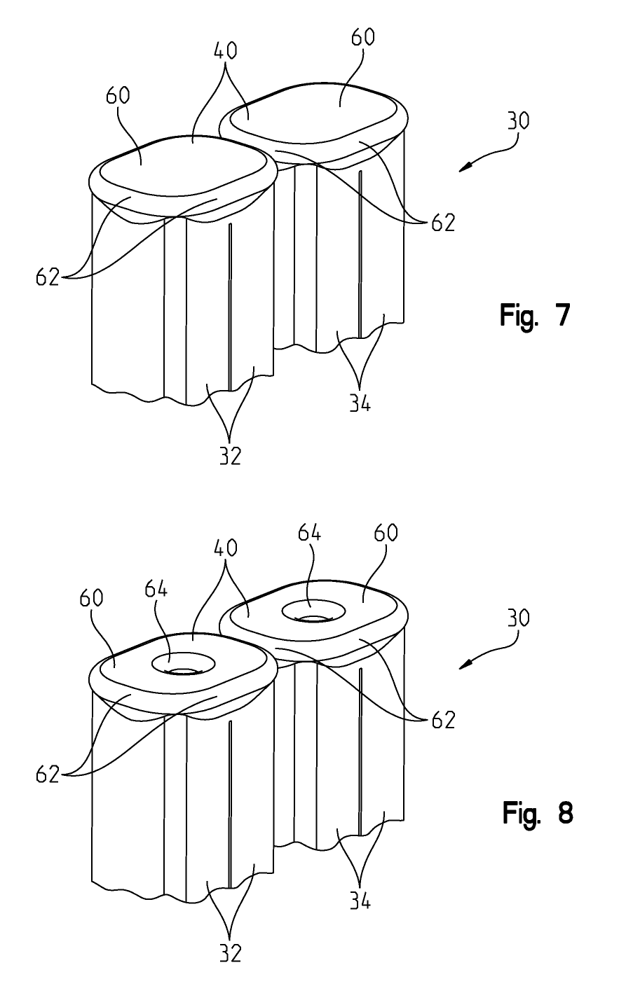

The coupling machine 100 may be configured to simultaneously join a plurality of pairs of conductors 30 (FIGS. 7 and 8). The coupling machine 100 also may be automated in order to efficiently form the joints 40 of the conductors 30. Additionally, the coupling machine 100 may be configured to index or rotate circumferentially around the stator assembly 10 to further increase the efficiency of the joining process. Likewise, the coupling machine may include a rotating support or platform (not shown) to index the stator assembly 10 for this purpose, as well.

Referring to FIGS. 3-6, an illustrative method of interconnecting or joining the ends 36, 38 of the conductors 30 is herein described in the following illustrative steps. The illustrative method includes a holding step, a joining step, and a forming step. While the illustrative method is described with reference to the inner conductors 32, the outer conductors 34 are joined in the same manner.

With reference to FIG. 3, the illustrative holding step may comprise clamping the conductors 30 by moving the clamps 42a, 42b in opposing directions 80, 82 along the radial direction R toward the ends 36 of the conductors 30. For example, the clamps 42a, 42b may be U-shaped and generally surround the conductors 30. The clamps 42a, 42b hold the ends 36 of the conductors 30 together. More particularly, the upper surface of the illustrative clamps 42a, 42b contact the conductors 30 at a height of approximately 30 millimeters from the top of the cylindrical wall 24 of the stator stack 20. In other words, the upper surface of the clamps 42a, 42b contact the conductors 30 approximately four millimeters below the uppermost surface of the ends 36, 38 of the conductors 30. It should be appreciated that the clamps 42a, 42b may contact the ends 36, 38 of the conductors 30 at any position along the height of the ends 36, 38 extending from the top of the cylindrical wall 24 of the stator stack 20. The ramps 43a, 43b of the respective clamps 42a, 42b are positioned adjacent to the ends 36 of the conductors 30.

The illustrative joining step is shown in FIG. 3 as comprising a welding apparatus, using the torch 44 to melt and fuse the ends 36 of the conductors 30, thereby welding the ends 36 together. To prepare the conductors 30 for welding, the ends 36 may be trimmed or otherwise cut or shaped. Additionally, any coating or insulation along the outer surface of the ends 36 may be removed, for example by a stripping process. The ends 36 may also be shaped or otherwise pointed prior to being melted and welded. More particularly, the ends 36 of the conductors 30 are welded together to form the joint 40 (FIGS. 4A, 5A, 6A).

Illustratively, the joining step is a standard plasma weld process, however, the joining step may include other fusing or welding process, such as arc welding, CO₂ gas shielded arc welding, and inert gas shielded metal arc welding (i.e., MIG welding). More particularly, the illustrative torch 44 may be operably coupled to a negative electrode of a welding power source (not shown) and is positioned above the ends 36 of the conductors 40. When the welding power source is operating, an inert gas (e.g., argon, helium) is supplied to the torch 44 in order to discharge an arc between the torch 44 and the ends 36 of the conductors. During the joining step, the illustrative torch 44 may be operated at approximately 130 amps for approximately 120 milliseconds to fuse together the ends 36 of the conductors 30. The joint 40 may have a round or arcuate surface that is raised and extends above a predetermined height H₁, illustratively defined by the upper surface of the clamps 42. Illustratively, the joint 40 extends to a height H₂, which is above the height H₁ (FIG. 4A).

Referring to FIGS. 4A-4B, the illustrative forming step is best performed while the weld joint 40 is still in a plastic or molten state. More particularly, the leading edge 70 and the engagement surface 47 contact the joint 40 as the radial forming die 46 moves or slides in the radial direction R. As shown in FIG. 4B, the radial forming die 46 moves across the entire surface of the joint 40 in order to flatten the raised surface of the joint 40. As such, the molten joint 40 is axially flattened to the height H₁ and, as a result, the joint 40 laterally expands toward the ramps 43 of the clamps 42 (FIG. 4B). Alternatively, the radial forming die 46 may having a rolling motion as it moves in the radial direction R across the joint 40. The radial forming die 46 is subsequently removed and the clamps 42 are released from the conductors 30 in opposing directions 84, 86 and the joint 40 is allowed to cool.

As shown in FIGS. 4C and 7, after the forming step, the joint 40 includes a formed surface 60 and lateral side extensions 62. The formed surface 60 of the joint 40 is substantially identical to the engagement surface 47 of the radial forming die 46. Illustratively, the formed surface 60 of the joint 40, and likewise the engagement surface 47 of the radial forming die 46, is substantially planar.

Alternatively, and with respect to FIGS. 5A-5B, the forming step may be performed with the axial forming die 48. Referring to FIGS. 5A and 5B, while the joint 40 is still in the molten state, the axial forming die 48 is applied to the joint 40 and moves downwardly in the axial direction A. As shown in FIG. 5B, the engagement surface 49 contacts the entire surface of the joint 40 to flatten the raised surface of the joint 40. As such, the molten joint 40 axially flattens to the height H₁ and, as a result, the joint 40 laterally expands toward the ramps 43 of the clamps 42 (FIG. 5B). As such, after the forming step, the joint 40 has an elongated shape defined by the formed surface 60 and the lateral side extensions 62 (FIG. 4C). The axial forming die 48 is subsequently removed and the clamps 42 are released from the conductors 30 in opposing directions 84, 86 and the joint 40 is allowed to cool.

As shown in FIGS. 4C and 7, the formed surface 60 of the joint 40 is substantially identical to the engagement surface 49 of the axial forming die 48. Illustratively, the formed surface 60 of the joint 40, and likewise the engagement surface 49 of the axial forming die 48, is substantially planar. However, an identifying mark on the engagement surface 49 of the axial forming die 48 can be transferred to the formed surface 60 of the joint 40 during the forming step.

Referring to FIGS. 6A-6B, another alternative forming step may be performed by the profile forming die 50. As shown in FIGS. 6A and 6B, when the joint 40 is still in the plastic or molten state, the profile forming die 50 moves in the axial direction A and the projection 54 of the profile forming die 50 initially extends into the center of the joint 40 to form a depression 64 (FIGS. 6C and 8). The engagement surface 56 subsequently contacts the remainder of the joint 40. The projection 54 improves the load distribution of the profile forming die 50 because a portion of the force applied to the joint 40 is distributed in a non-axial direction. As shown in FIG. 6B, the profile forming die 50 extends across the entire molten surface of the joint 40 to flatten the raised surface of the joint 40. As such, the molten joint 40 is axially flattened to the height H₁ and, as a result, the joint 40 laterally expands toward the ramps 43 of the clamps 42 (FIG. 6B). The profile forming die 50 is subsequently removed and the clamps 42 are released from the conductors 30 in opposing directions 84, 86 and the joint 40 is allowed to cool.

The surface of the joint 40 includes the depression 64, which matches the shape of the projection 52 of the profile forming die 50 and the formed surface 60, which has substantially planar portions matching the profile of the engagement surface 56 of the profile forming die 50. An identifying mark on the engagement surface 56 of the profile forming die 50 may be transferred to the formed surface 60 of the joint 40 during the forming step.

The forming step is completed when the joint 40 is flattened to the height H₁, which is the height (h) of the joint 40 as measured from the top of the joint 40 to the top of the cylindrical wall 24 of the stator stack 20 (FIGS. 4C, 6C). The illustrative height H₁ is arranged at the level of the upper surface of the clamps 42, however, the height H₁ may be any predetermined level or datum plane with respect to the stator assembly 10 or the joint 40. Illustratively, the difference between the height H₁ and the height H₂ may be approximately 0.04 inches (approximately 1.0 millimeter) to approximately 0.08 inches (approximately 2.0 millimeters). However, if the height H₁ is set too close to the cylindrical wall 24 of the stator stack 20, the current flowing through the conductors 30 may arc and cause a shorting event in the stator assembly 10. By controlling the height (h) of the joints 40 at a predetermined level (e.g., the height H₁), the overall package size of the stator assembly 10 may be reduced in a consistent and predictable manner. For example, the height (h) of the joint 40 may be approximately 30 millimeters to approximately 36 millimeters, depending on the requirements and application of the stator assembly 10.

Referring to FIGS. 7 and 8, it should be appreciated that the ramps 43 of the clamps 42 provide the necessary space for the joint 40 to expand during the forming step. As such, the forming step alters the shape of the joint 40 but does not remove any material from the joint 40, thereby decreasing the possibility of contaminating the stator assembly 10. Additionally, after the forming step, the elongated shape of the joint 40 has an increased surface area relative to the arcuate shape of the joint 40 before the forming step. The increased surface area of the joint 40 dissipates more heat as current flows through the joint 40 during operation of the stator assembly 10.

Also, it should be appreciated that the forming step does not reduce the area through which the current will flow because no material is removed from the joint 40. Conversely, when material is removed from the joint 40, such as through a cold-working process (e.g., machining), the area through which the current flows may decrease, thereby increasing the resistance in the joint 40 during operation of the stator assembly 10. As such, the illustrative method of the present disclosure may dissipate heat in the joint 40 without increasing the resistance in the joint 40 when current is flowing.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method of joining a plurality of electrical conductors in an electric machine, the method comprising the steps of:
providing a core;
positioning the plurality of conductors within the core in concentric rings, the conductors including ends extending from the core;
holding together at least two adjacent ends of the conductors;
joining the adjacent ends to form a joint;
forming the joint to include at least a substantially planar portion; and
releasing the adjacent ends of the conductors.

2. The method of claim 1, wherein the holding step includes providing opposing clamps to secure together the adjacent ends of the conductors.

3. The method of claim 1, wherein the joining step includes welding the adjacent ends.

4. The method of claim 1, wherein the forming step further includes providing a forming device with at least a substantially planar portion, and engaging the joint with the substantially planar portion of the forming device after the welding step and while the joint is still molten.

5. The method of claim 4, wherein the substantially planar portion of the forming device engages the joint in an axial direction.

6. The method of claim 4, wherein the substantially planar portion of the forming device slides across the joint along a radial direction.

7. The method of claim 4, wherein the forming device includes an identifying mark for transfer to the joint.

8. The method of claim 4, wherein a protrusion extends from the forming device and forms a depression in the joint.

9. A method of joining a plurality of electrical conductors in an electric machine, the method comprising the steps of:
providing a core;
positioning the plurality of conductors within the core, each conductor including an end extending from the core;
joining a pair of adjacent ends of the conductors with heat to form a joint, the joint including a raised arcuate surface; and
engaging the joint with a forming device at a predetermined level below the raised arcuate surface of the joint.

10. The method of claim 9, further comprising the step of holding together the pair of adjacent ends with opposing clamps.

11. The method of claim 10, further comprising the step of releasing the pair of adjacent ends of the conductors.

12. The method of claim 9, further comprising the step of moving the forming device along at least one of an axial direction and a radial direction.

13. The method of claim 9, wherein the joint includes at least a substantially planar portion.

14. The method of claim 9, wherein the forming device includes an identifying mark for transfer to the joint.

15. The method of claim 9, wherein a protrusion extends from the forming device and forms a depression in the joint.

16. The method of claim 9, wherein the joining step includes forming a second joint from a second pair of adjacent ends of the conductors.

17. The method of claim 16, wherein the engaging step includes applying the forming device to the second joint at the predetermined level such that a height of the first joint is substantially equal to a height of the second joint.

18. The method of claim 9, wherein the engaging step increases the surface area of the joint relative to the surface area of the raised arcuate surface of the joint.

19. An electric machine assembly, comprising:
a core; and
a plurality of electrical conductors supported by the core in an axial direction and forming concentric rings, each conductor including an end extending from the core, each end of the conductors being coupled to an adjacent end of the conductors to form a joint, the joint having at least a substantially planar portion perpendicular to the axial direction.

20. The electric machine of claim 19, wherein the joint includes an identifying mark.

21. The electric machine of claim 19, wherein the joint includes a depression generally surrounded by the substantially planar portion.

22. The electric machine of claim 19, wherein the joint is a weldment.

23. The electric machine of claim 19, wherein the joint includes a plurality of lateral side extensions.
